(19) United States
(12) Patent Application Publication
(10) Pub. No.: US 2010/0020432 A1
(43) Pub. Date: Jan. 28, 2010

(54) MAGNETIC DISK APPARATUS AND MAGNETIC DISK ACCESS CONTROL METHOD

(75) Inventors: Mineo Moribe, Kawasaki (JP); Masakazu Taguchi, Kawasaki (JP); Atsushi Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/480,375

(22) Filed: Jun. 8, 2009

(30) Foreign Application Priority Data
Jul. 28, 2008 (JP) 2008-193190

(51) Int. Cl. G11B 15/18

(52) U.S. Cl. 360/71; G9B/15.021

(57) ABSTRACT

A magnetic disk apparatus includes a magnetic disk provided with a data recording area and a servo-pattern area. The data recording area includes a non-magnetic area scattered with magnetic regions, and the servo-pattern area includes a plurality of magnetic regions each having a larger area than the magnetic regions in the data recording area. The magnetic disk apparatus also includes a reader for reading magnetization in the data recording area and the servo-pattern area, and a magnetizer for application of a magnetic field to the magnetic regions in the servo-pattern area for equalizing magnetization directions of the magnetic regions in the servo-pattern area before the reader starts to read the servo-pattern area.

### FIELD

An embodiment of the present invention relates to a magnetic disk apparatus suitable for perpendicular magnetic recording. Another embodiment of the present invention relates to a magnetic disk access control method.

### BACKGROUND

Currently, proposals are made for perpendicular magnetic recording as an alternative to horizontal magnetic recording. In horizontal magnetic recording, recording dots have a magnetization direction along the recording plane in the magnetic recording layer. Perpendicular magnetic recording has an advantage over the horizontal magnetic recording in that recording density can be increased easily. In perpendicular magnetic recording, recording dots have a magnetization direction in the thickness direction in the magnetic recording layer. A magnetic disk apparatus suitable for perpendicular magnetic recording is disclosed in JP-A 2003-157507, in which the magnetic disk apparatus includes a bit patterned medium as a recording medium. In the bit patterned medium, magnetic regions each representing a recording dot are spaced from each other equidistantly.

Bit patterned media have a data recording area which is a non-magnetic area scattered with magnetic regions, and a servo-pattern area which is used for disk access control such as magnetic head positioning control and clock signal generation. The servo-pattern area is formed with a large number of belt-like magnetic regions extending substantially radially of the magnetic disk. In the data recording area each magnetic region is given a magnetization direction as a representation of a datum to be recorded whereas in the servo-pattern area all of the magnetic regions are given the same magnetization direction in a formatting procedure which is performed, generally, during the manufacturing process.

### BRIEF DESCRIPTION OF DRAWINGS

FIG. 1 is a perspective view illustrating a magnetic disk apparatus.

FIG. 2 is a block diagram of the magnetic disk apparatus.

FIGS. 3A-3C illustrate a magnetizing operation.

FIG. 4 is a flowchart for describing a disk access control.

FIG. 5A and FIG. 5B illustrate a magnetizing operation according to another embodiment.

FIG. 6 is a perspective view illustrating a magnetic disk apparatus according to another embodiment.

FIG. 7A and FIG. 7B illustrate mutually adjacent magnetic domains.

### DESCRIPTION OF EMBODIMENTS

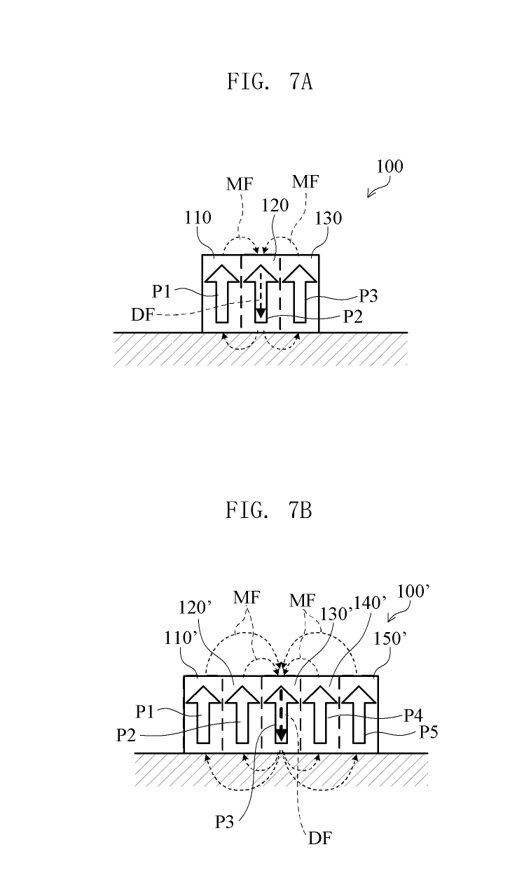

As illustrated in FIG. 7A, a magnetic region 100 is made up of polycrystalline crystal grains and includes a plurality of magnetic domains 110-130, each of which is bordered by a crystal grain boundary and functions as a unit for generation of magnetization directions P1-P3. The magnetic domains 110-130 included in the magnetic region 100 have a strong magnetic exchange coupling force. Thus, the magnetic region 100 can be magnetized in one direction.

FIG. 7B illustrates a magnetic region 100′ which is larger than the region illustrated in FIG. 7A. Accordingly, the magnetic region 100′ includes a larger number of magnetized magnetic domains 110′-150′. Taking the middle magnetic domain 130′ for example, the domain is acted upon by the magnetic fields MF which are generated by the sandwiching magnetic domains 110′, 120′, 140′ and 150′. As the area of the magnetic region 100′ increases, the influence of the magnetic fields MF becomes greater, resulting in a large demagnetizing field DF acting on the magnetic domains. This may imply that the magnetic region 100′ has a smaller coercive force as its area becomes larger, and therefore the magnetization directions P1-P5 in a large magnetic region 100′ can be reversed easily by external magnetic disturbances.

This affects the disk access control servo-pattern area. Specifically, the disk access control servo-pattern area contains a large number of magnetic regions each having a larger area than the magnetic regions in the data recording area. Thus, even when the magnetic regions initially have a perfectly uniform magnetization direction, the magnetization direction is reversed by external disturbances in some of the magnetic regions. Once the reversing of magnetization direction occurs in the servo-pattern area, it becomes no longer possible to make correct magnetic recognition of the magnetic regions in the servo-pattern area. This leads to troubles in magnetic head positioning control and clock signal generation, and to inability to perform proper disk access control.

According to an aspect of the present invention, it is possible to make correct magnetic recognition of the servo-pattern area, and hence enable proper disk access control.

A magnetic disk apparatus according to an embodiment includes a magnetic disk, a magnetic head and a magnetizer. The magnetic disk is provided with a data recording area and a servo-pattern area, where the data recording area is provided by a non-magnetic area scattered with magnetic regions, and the servo-pattern area includes a plurality of magnetic regions each having a larger area than the magnetic regions in the data recording area. The magnetic head is arranged to reciprocate radially of the magnetic disk. The magnetic head magnetizes the magnetic regions in the data recording area in a certain direction or directions, and also reads the magnetization directions of the magnetic regions in the data recording area and the servo-pattern area. The magnetizer magnetizes the magnetic regions in the servo-pattern area for equalization in magnetization direction before the magnetic head starts reading the servo-pattern area.

An access control method for a magnetic disk apparatus is provided according to another embodiment. In the access control method, for example, a magnetizing step, a reading step and a magnetic head controlling step may be performed. The magnetic disk has a data recording area provided by a non-magnetic area scattered with magnetic regions, and a servo-pattern area includes a plurality of magnetic regions each having a larger area than the magnetic regions in the data recording area. The magnetic head is arranged to reciprocate radially of the magnetic disk, gives a magnetization direction to the magnetic regions in the data recording area, and reads the magnetization direction of the magnetic regions in both the data recording area and the servo-pattern area. In the access control method, the magnetic head reads the servo-pattern area before recording or reproducing operation with respect to the data recording area. In the magnetizing step, a magnetizing operation is performed to the magnetic regions in the servo-pattern area for equalization in magnetization direction before the magnetic head starts reading of the servo-pattern area. In the reading step, the magnetic head reads the equally magnetized servo-pattern area. In the magnetic head controlling step, the magnetic head is controlled based on a servo reproduction signal obtained in accordance with the magnetization in the magnetic regions of the servo-pattern area for performing a recording or reproducing operation to the data recording area.

The magnetization direction of the magnetic regions in the servo-pattern area is corrected back to the initial, uniform state before the magnetic head reads a servo-pattern area. Accordingly, the servo-pattern area is recognized correctly, and disk access control is performed properly.

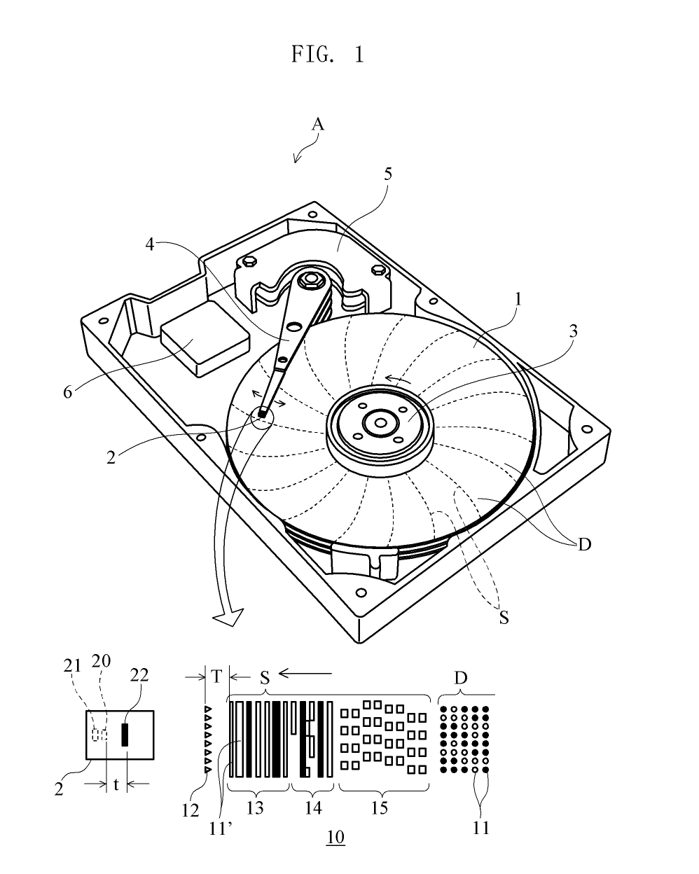

FIGS. 1-4 illustrate a magnetic disk apparatus according to an embodiment of the present invention. As illustrated in FIG. 1, the magnetic disk apparatus A includes magnetic disks 1, a magnetic head (or heads) 2, a spindle motor 3, a swing arm 4, a voice coil motor 5, and a disk controller 6.

The magnetic disks 1 are provided by a bit patterned medium, and each disk has an upper and a lower surfaces both serving as a recording surface.

The magnetic head 2, configured to read/write magnetic information from/to the magnetic disk 1, is incorporated in a slider which is provided at an end of the swing arm 4, being faced to the surface of the magnetic disk 1. The magnetic head 2 is provided with magnetically operational elements such as a reproducing element 20 and a recording element 21, which perform reading and writing of magnetic information, respectively. The reproducing element 20 and the recording element 21 are placed next to each other generally in the circumferential direction of the magnetic disk 1. On an upstream side with respect to the magnetic disk's rotational direction, a magnetizer 22 is placed at an appropriate location in the magnetic head 2. The magnetizer 22 is provided by an electric magnet which is magnetically shielded from the reproducing element 20 and the recording element 21, and is controlled so as to magnetize the magnetic disk 1 in the predetermined one direction only.

The spindle motor 3 turns the magnetic disk 1 at a high speed. The swing arm 4, which is swung by the voice coil motor 5, moves the magnetic heads 2 in a reciprocating path in a generally radial direction of the magnetic disk 1. The magnetic heads 2, the spindle motor 3, and the voice coil motor 5 are controlled by the disk controller 6. The disk controller 6 is provided by e.g. a microcomputer which includes a CPU, a memory, etc., or by a wired logic circuit which is an equivalent to the microcomputer.

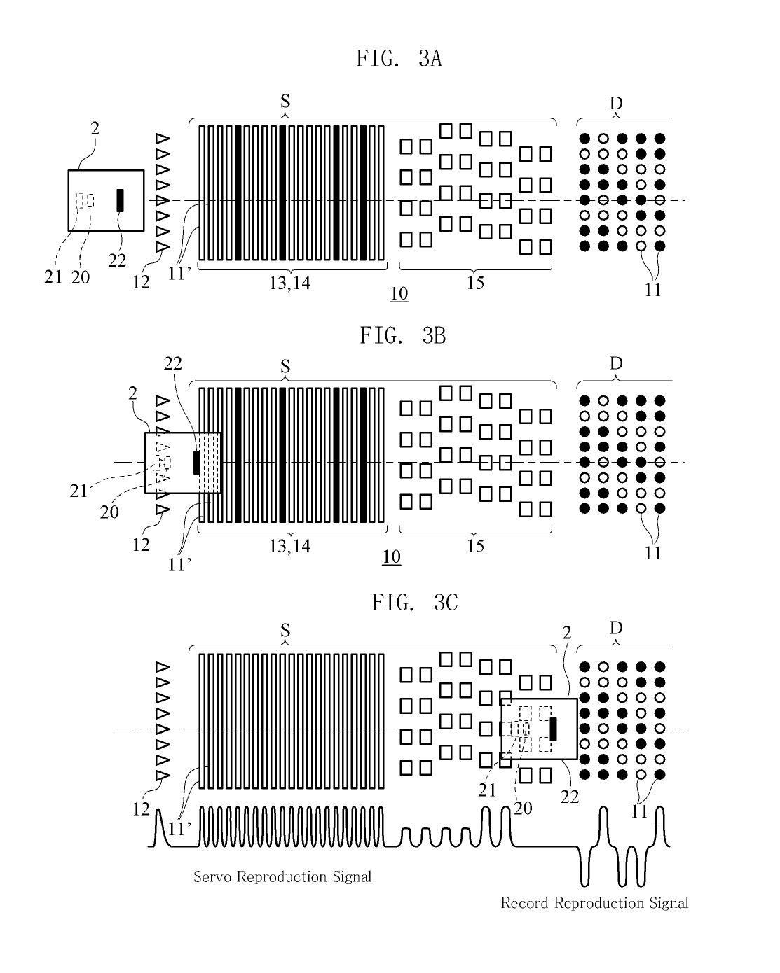

As illustrated in FIG. 1 and FIG. 3, the magnetic disk 1 is provided with a plurality of servo-pattern areas S so as to divide a data recording area D along the path of the magnetic head 2. The data recording area D, which is an area where recording/reproducing of magnetic information is performed, is a non-magnetic area 10 dotted with magnetic regions 11 arranged equidistantly in a circumferential direction of the magnetic disk 1. Magnetic information is recorded/reproduced in the form of magnetization direction at each of the magnetic regions 11, i.e., whether the magnetization is made in an upward direction or in a downward direction along the thickness of the magnetic disk 1.

As illustrated in FIG. 1, the servo-pattern area S is preceded by magnetic regions which serve as a reading start mark 12. The reading start mark 12 is formed of a shape which cannot be found elsewhere. The reading start mark 12 is formed of triangular magnetic regions for example. The reading start mark 12 and the servo-pattern area S are spaced from each other by a distance T which is not smaller than a distance t between the reproducing element 20 and the magnetizer 22. With the distances T and t provided as the above, the magnetizer 22 is controlled so that it performs a magnetizing operation to the servo-pattern area S after the reproducing element 20 has detected the reading start mark 12. In other words, magnetization to the servo-pattern area S is performed before the reproducing element 20 starts reading of the servo-pattern area S.

The servo-pattern area S includes a preamble section 13, an address section 14 and a burst pattern section 15. The preamble section 13 provides a reference when the magnetic head 2 performs recording/reproducing operations to/from the address section 14, the burst pattern section 15 and the data recording area D. The preamble section 13 is provided for generation of clock signals. The preamble section 13 is a non-magnetic area 10 formed with a plurality of long and narrow magnetic regions 11′ each having a larger area than the magnetic region 11 in the data recording area D and extending generally in the radial direction of the magnetic disk 1. The address section 14, which provides address information such as a track number and a sector number, is a non-magnetic area 10 including magnetic regions 11′ patterned to the address information. The burst pattern section 15 provides a pattern for fine tuning in tracking. The burst pattern section 15 includes rectangular magnetic regions arranged in a predetermined layout pattern. In the present embodiment, a reference symbol is assigned to magnetic regions 11′ of the preamble section 13 and of the address section 14. These magnetic regions 11′ extend generally in the radial direction of the magnetic disk 1, giving a large area. In another tracking method, however, the magnetic regions in the burst pattern section may also be extended generally in the radial direction of the magnetic disk to have a large area.

The servo-pattern area S described above is magnetized by the manufacturing process in a manner such that the magnetization direction is the same for all the magnetic regions 11′. As noted above, the servo-pattern area S includes a large number of magnetic regions 11′ which have a larger area than that of the magnetic regions 11 in the data recording area. Accordingly, magnetic regions 11′ in the servo-pattern area S are more susceptible than magnetic regions 11 in the data recording area D to magnetization direction reversal, which can be caused by external disturbances. Referring to FIGS. 1 and 3, the servo-pattern area S originally has all of its magnetic regions 11′ magnetized in the same direction in the manufacturing process as indicated by white magnetic region 11′, but eventually will have magnetic regions 11′ magnetized in the reverse direction as indicated by black magnetic regions 11′ due to external magnetic disturbances. In FIGS. 3, the preamble section 13 and the address section 14 are depicted as having the same pattern for simplicity of illustration.

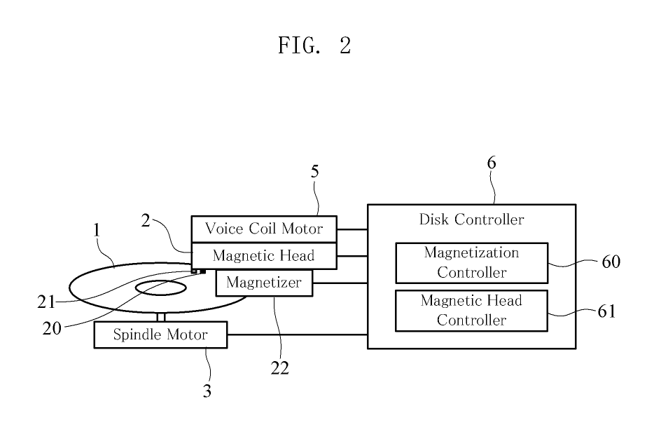

As illustrated in FIG. 2, the disk controller 6 includes such function modules as a magnetization controller 60 and a magnetic head controller 61 in addition to other function modules (not illustrated) which control the spindle motor 3 and the voice coil motor 5.

The magnetization controller 60 provides control so that the magnetizer 22 performs a magnetization operation immediately after the reproducing element 20 has detected the reading start mark 12. The servo-pattern area S has a predetermined length measured circumferentially of the magnetic disk 1, and the operation of the magnetizer 22 is caused to stop after the length has been covered, or, after the lapse of a predetermined time known to be taken for going the distance. By this arrangement, the magnetizer 22 has been deactivated when it begins to pass the data recording area D and hence, the data recording area D is not magnetized by the magnetizer 22.

The magnetic head controller 61 controls operations of the reproducing element 20 and the recording element 21 in the magnetic head 2 based on a servo reproduction signal obtained by reading of the servo-pattern area S. Now, with reference to FIG. 3C, description will be made for a case where the servo-pattern area S has been read by the reproducing element 20. The reading yields a servo reproduction signal, and based on a timing given by this servo reproduction signal, the magnetic head controller 61 controls the recording element 21. As a result, magnetization directions as illustrated in FIG. 3 are recorded accurately in the magnetic region 11 of the data recording area D. When reproducing, an output signal from the reproducing element 20 is processed based on a timing given by the servo reproduction signal, whereby accurate reading is made of the magnetic information recorded in the magnetic region 11 of the data recording area D in the form of magnetization direction.

It should be noted here that the reading start mark is not the only option for use: Examples of other options include a specific position in the previous sector, such as the last dot position of the servo-pattern area and the last dot position of the data recording area. These positions may be used as a reference point to measure the travel time to locate the starting point of the servo-pattern area in the target sector.

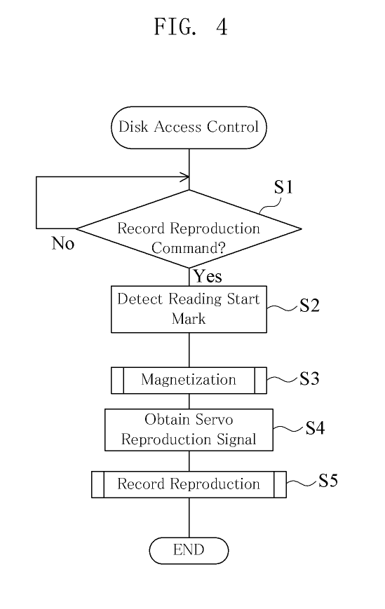

Next, an operation of the magnetic disk apparatus A will be described with reference to FIG. 3 and FIG. 4. FIG. 3 is a conceptual diagram for describing a magnetizing operation whereas FIG. 4 is a flowchart for describing a disk access control procedure.

First, when a recording/reproducing command is issued from e.g. a host computer to the magnetic disk apparatus A (S1: YES), the magnetization controller 60 detects, by using the reproducing element 20 of the magnetic head 2, the reading start mark 12 which lies before the target servo-pattern area S (S2). At this point, the magnetic head 2 is as illustrated in FIG. 3B, namely, the magnetizer 22 is just about to enter the servo-pattern area S.

Upon the detection of the reading start mark 12, the magnetization controller 60 operates the magnetizer 22 to perform a magnetizing operation (S3). The magnetizing operation corrects any reversed magnetization; namely, as illustrated in FIG. 3B, the servo-pattern area S before the magnetizing operation includes magnetic regions 11′ which have a reversed magnetization direction; however, as illustrated in FIG. 3C, after being passed by the magnetizer 22, all of the magnetic regions 11′ have the same magnetization direction.

In addition to the magnetizing operation as described above, the magnetic head controller 61 employs the reproducing element 20 to read the servo-pattern area S and thereby obtain a servo reproduction signal (S4). The servo reproduction signal thus obtained is recognized correctly as a flawless pulse signal of a positive signal level because all of the magnetic regions 11′ have the same magnetization direction as a result of the magnetizing operation which has been just performed. Such a servo reproduction signal is used as a reference signal for controlling the magnetic head 2 in recording/reproducing operations.

Thereafter, as the magnetic head 2 enters the data recording area D, the disk controller 6 controls the recording element 21 or the reproducing element 20 of the magnetic head 2 based on the servo reproduction signal to perform a recording/reproducing procedure to the data recording area D (S5). In the case of recording for example, magnetization is performed to magnetic regions 11 in the data recording area D at a timing appropriate to their spacing to record intended information in the form of magnetization directions. Also, in the case of reproducing, reading is performed to the magnetic regions 11 in the data recording area D by the timing corresponding to their spacing to read magnetization directions as the stored information.

If the step S1 does not find a recording/reproducing command to the magnetic disk apparatus A (S1: NO), the disk controller 6 waits until a recording/reproducing command is issued.

With the above operation, even if the magnetization direction in magnetic regions 11′ of the servo-pattern area S is in the reversed state, the reversed direction is corrected by the magnetizing operation which is performed right before the reproducing element 20 reads the magnetic regions 11′. This ensures correct magnetic reading of the servo-pattern area S by the reproducing element 20 and as a result, ensures a correct and smooth recording/reproducing operation thorough a disk access control which is based on the obtained servo reproduction signal.

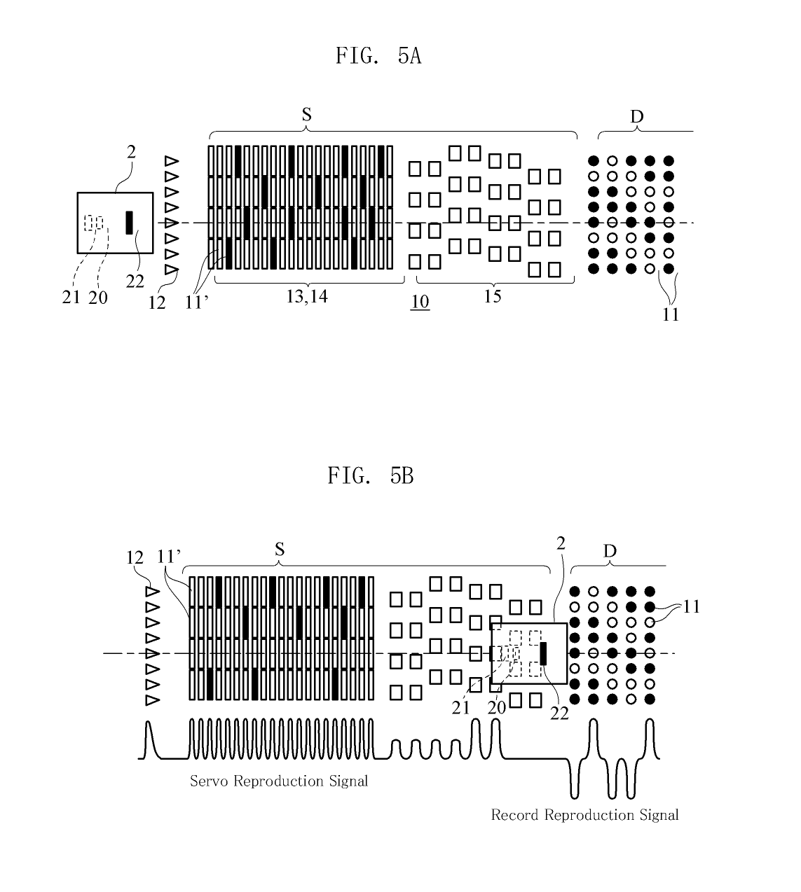

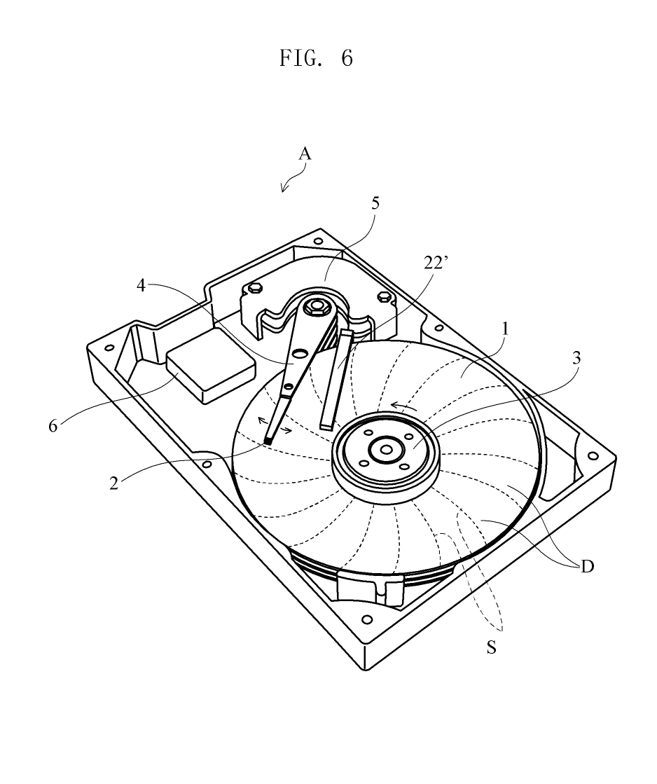

FIG. 5 and FIG. 6 illustrate other embodiments of the present invention. In these embodiments, elements equivalent or similar to those in the previous embodiment are indicated by the same reference symbols, and their detailed description may be omitted.

In the magnetic disk apparatus in FIG. 5, the preamble section 13 and the address section 14 in the servo-pattern area S include a plurality of magnetic regions 11′. These magnetic regions 11′ are divided radially of the magnetic disk. Magnetic regions 11′ of such a type as described above are also larger than magnetic regions 11 in the data recording area D and therefore, their magnetization direction tends to be reversed easily. Such a servo-pattern area S can also benefit from the magnetizing operation as described in the previous embodiment, i.e., it is possible to obtain a servo reproduction signal which has a proper signal level and it is possible to control the magnetic head 2 based on the servo reproduction signal. Thus, magnetically correct reading of the servo-pattern area S is ensured. As a result, a correct and smooth recording/reproducing operation is performed thorough a disk access control based on the servo reproduction signal.

FIG. 6 illustrates a magnetic disk apparatus A′ which is provided with a magnetizer 22′ on a more upstream side than a reciprocation path of the magnetic head 2 with respect to the rotational direction of magnetic disk 1. The magnetizer 22′ is provided by a permanent magnet which applies a magnetic field of a fixed direction constantly to the magnetic disk 1, and is provided to cover an entire area along its path substantially radially of the magnetic disk 1. The permanent magnet used in the magnetizer 22′ as described above has a level of magnetic field strength which is not able to reverse the magnetization direction in the data recording area D but is able to reverse the magnetization direction in magnetic regions of a weaker coercive force in the servo record area S. According to the magnetic disk apparatus A′ as described above, it is also possible, by using the magnetizer 22′, to correct the magnetization direction in the servo-pattern area S uniformly into the same direction before the magnetic head 2 reads the servo-pattern area S. Therefore, magnetically correct reading is made from the servo-pattern area S and as a result, a correct and smooth recording/reproducing operation is performed thorough a disk access control based on the obtained servo reproduction signal. It should be noted here that such a magnetizer as the above may be disposed in the slider, i.e. at an appropriate position in the slider which is more upstream of the reproducing element of the magnetic head in the magnetic disk's rotational direction. The magnetizer may be provided by a permanent magnet, for example. The closer is the magnetizer to the magnetic head on the upstream side with respect to the magnetic disk's rotational direction, the sooner is the reading made to servo-pattern area after the magnetization. As a result, there is less chance for reversed magnetization direction in the servo-pattern area by external magnetic disturbances.

It is to be understood that the embodiments described above are exemplary and not restrictive of the invention, as claimed.

What is claimed is:

1. A magnetic disk apparatus comprising:
a magnetic disk including a data recording area and a servo-pattern area, the data recording area being provided by a non-magnetic area scattered with magnetic regions, the servo-pattern area including a plurality of magnetic regions each having a larger area than the magnetic regions in the data recording area;
a reader for reading magnetization in the data recording area and the servo-pattern area; and
a magnetizer for application of a magnetic field to the magnetic regions in the servo-pattern area for equalizing magnetization directions of the magnetic regions in the servo-pattern area before the reader starts to read the servo-pattern area.

2. The magnetic disk apparatus according to claim 1, further comprising a magnetic head reciprocable radially of the magnetic disk, wherein the reader is provided on the magnetic head, and the magnetizer is provided upstream of the magnetic head in a rotational direction of the magnetic disk.

3. The magnetic disk apparatus according to claim 2, wherein the magnetic head includes a recording section for application of a magnetic field for recording data in the data recording area, and the magnetizer comprises a permanent magnet for applying to the magnetic disk a magnetic field weaker than the magnetic field by the recording section.

4. The magnetic disk apparatus according to claim 1, further comprising a recording section for application of a magnetic field for recording data in the data recording area, wherein the magnetizer is provided upstream of the recording section in a rotational direction of the magnetic disk, the magnetizer being controlled for application of the magnetic field while passing the servo-pattern area.

5. The magnetic disk apparatus according to claim 4, wherein the reader detects, based on a reading start mark, a position where the magnetizer starts to pass the servo-pattern area, and the reading start mark has a different shape from the magnetic regions and is provided downstream of the servo-pattern area in the rotational direction of the magnetic disk.

6. A magnetic disk access control method for a magnetic disk provided with a data recording area and a servo-pattern area, the data recording area including a non-magnetic area scattered with magnetic regions, the servo-pattern area including a plurality of magnetic regions each having a larger area than the magnetic regions in the data recording area, in the method a reader is used for reading magnetization directions in the magnetic regions of the data recording area and the servo-pattern area, the method comprising:
a magnetizing step of applying a magnetic field to the magnetic regions in the servo-pattern area for equalizing magnetization directions before the reader starts reading with respect to the servo-pattern area; and
a recording/reproducing control step of reading the magnetized servo-pattern area by the reader and performing a recording or reproducing operation to the data recording area based on a servo reproduction signal obtained in accordance with the magnetization of the magnetic regions in the servo-pattern area.
